(19) United States
(12) Patent Application Publication
(10) Pub. No.: US 2009/0164907 A1
(43) Pub. Date: Jun. 25, 2009

(54) DATA DISPLAY METHODS AND SYSTEMS

(76) Inventors: Wei-Ting HSIEH, Taoyuan County (TW); Yi-Hua WANG, Taoyuan County (TW); Fu-Chiang CHOU, Taoyuan County (TW)

Correspondence Address: BIRCH STEWART KOLASCH & BIRCH, PO BOX 747, FALLS CHURCH, VA, 22040-0747, US

(21) Appl. No.: 12/332,036

(22) Filed: Dec. 10, 2008

(30) Foreign Application Priority Data
Dec. 24, 2007 (TW) 96149691

(51) Int. Cl. G06F 3/14

(52) U.S. Cl. 715/733

(57) ABSTRACT

Data display methods and systems for use in an electronic device are provided. First, data is provided. Then, a display format is determined according to a browsing mode of the electronic device, and the data is displayed based on the display format.

### CROSS REFERENCE TO RELATED APPLICATIONS

This Application claims priority of Taiwan Patent Application No. 096149691, filed on Dec. 24, 2007, the entirety of which is incorporated by reference herein.

### BACKGROUND OF THE INVENTION

1. Field of the Invention

The disclosure relates generally to data display methods and systems, and, more particularly to methods and systems that display data in various display formats according to a browsing mode of an electronic device.

2. Description of the Related Art

Recently, portable devices, such as handheld devices, have become more and more technically advanced and multifunctional. For example, a handheld device may have email message capabilities, an advanced address book management system, a media playback system, and other functions. Due to increased convenience and functions of the devices, these devices have become necessities of life.

Since the height and width of the screen of a handheld device may be different, the handheld device provides various browsing modes, such as a portrait mode and a landscape mode to display data in various effects. In some applications, data displayed in a specific display format can help users to easily and clearly realize the meaning of data. For example, data can be displayed via various display formats, such as a table format and a figure format. Data displayed via the figure format can easily show the relationship between data items. In some applications, for a specific topic, such as a music album, the required data and corresponding display formats for display in the portrait mode and the landscape mode are different. For example, a table of detailed songs of the music album is displayed in the portrait mode, and a cover figure of the music album is displayed in the landscape mode.

Generally, respective browsing modes may have a suitable display format. For example, the table format is suitable for the portrait mode, and the figure format is suitable for the landscape mode. Conventionally, when the browsing mode is switched, the display format for data is not changed, but only the manner of arrangement (composing) of data or the size for the display format is adjusted according to the screen situation. Since the display format will not be changed for various browsing modes, users must always make adjustments to locate a specific browsing mode having the best display effect to display data.

### BRIEF SUMMARY OF THE INVENTION

Data display methods and systems are provided.

In an embodiment of a data display method for use in an electronic device, data is provided. Then, a display format is determined according to a browsing mode of the electronic device, and the data is displayed based on the display format.

An embodiment of a data display system comprises a display unit, a storage unit comprising data, and a processing unit. The processing unit determines a display format according to a browsing mode of an electronic device, and displays the data based on the display format in the display unit.

Data display methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a data display system of the invention;

FIG. 2 is a schematic diagram illustrating an embodiment of a storage unit;

FIG. 3 is a flowchart of an embodiment of a data display method of the invention;

FIG. 4 is a flowchart of an embodiment of a method for browsing mode determination of the invention;

FIG. 5 is a schematic diagram illustrating a picture for stock information in the portrait mode of the invention; and

FIG. 6 is a schematic diagram illustrating a picture for stock information in the landscape mode of the invention.

### DETAILED DESCRIPTION OF THE INVENTION

Data display methods and systems are provided.

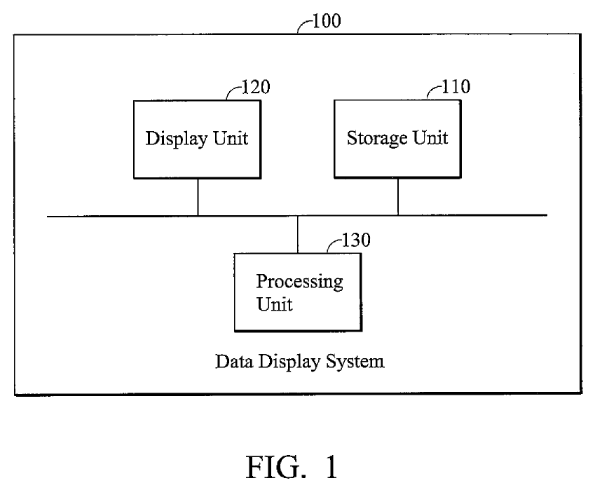

FIG. 1 is a schematic diagram illustrating an embodiment of a data display system of the invention. The data display system can be used in an electronic device, such as a portable device comprising a handheld device, such as a media player, a PDA (Personal Digital Assistant), a GPS (Global Positioning System) device, a smart phone, and a mobile phone.

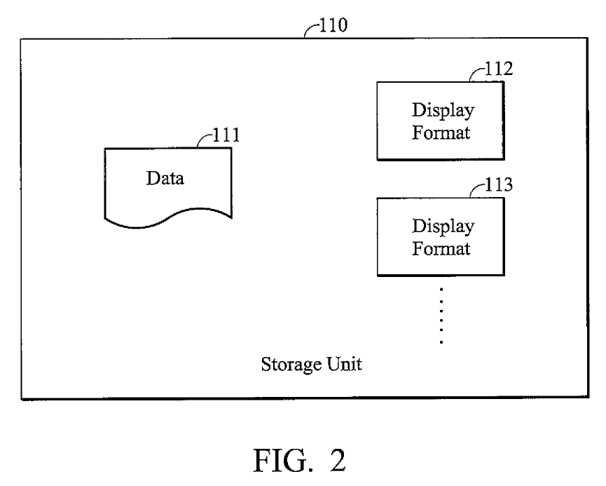

The data display system 100 comprises a storage unit 110, a display unit 120, and a processing unit 130. The storage unit 130 comprises data 111, and various display formats (112 and 113) for various browsing modes, as shown in FIG. 2. In this embodiment, each browsing mode may have a corresponding display format, and each display format defines a display manner, such as table or figure of data to be displayed in the display unit 120. The display unit 120 displays data according to the display formats of the respective browsing modes, and related pictures. The processing unit 130 performs the data display methods of the application, which will be discussed further in the following paragraphs.

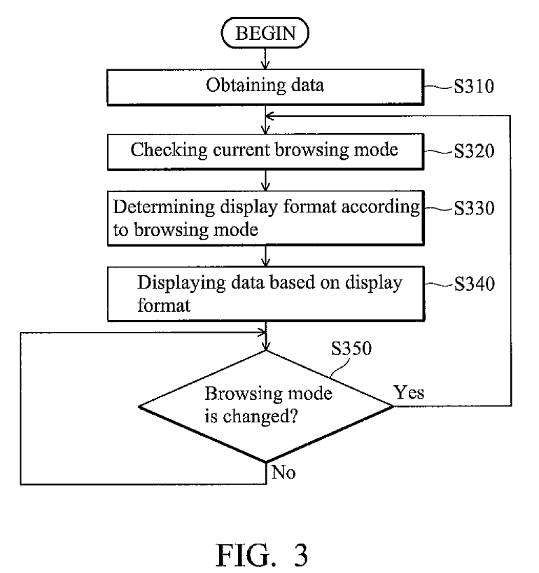

FIG. 3 is a flowchart of an embodiment of a data display method of the invention. The data display method is used for an electronic device having a touch-sensitive device.

In step S310, data is obtained, and in step S320, a current browsing mode of the electronic device is checked. It is understood that, the electronic device may provide several browsing modes, such as the portrait mode and the landscape mode to browse data. In step S330, a display format is determined according to the current browsing mode. In some embodiments, each browsing mode may have a corresponding display format, and the relationship between the browsing modes and the display formats can be recorded in the storage unit in advance. In step S340, data is displayed based on the determined display format. It is understood that the display of the data comprises calculation of an output picture conforming to the display format according to the data, and display of the output picture in the display unit. In step S350, it is determined whether the browsing mode of the electronic device has been changed. If the browsing mode has not changed (No in step S350), the procedure remains at step S350. If the browsing mode has been changed (Yes in step S350), steps S320 to S350 are repeated. It is noted that, when the browsing mode has been changed, the data originally used in the display format of the old browsing mode is completely used in the display format of the new browsing mode.

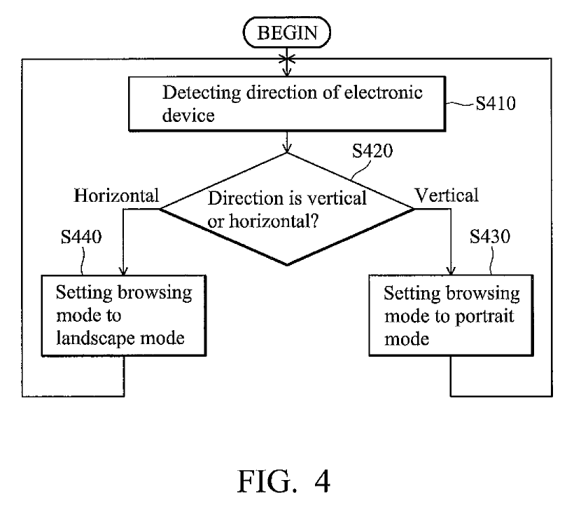

FIG. 4 is a flowchart of an embodiment of a method for browsing mode determination of the invention. The method for browsing mode determination is used for an electronic device having a motion sensor. The motion sensor can detect a direction of the electronic device. In this embodiment, the browsing mode can be set according to the direction of the electronic device.

In step S410, a direction of the electronic device is detected by the motion sensor. In step S420, it is determined whether the direction of the electronic device is vertical or horizontal. When the direction of the electronic device is vertical, in step 8430, the browsing mode of the electronic device is set to the portrait mode. When the direction of the electronic device is horizontal, in step S440, the browsing mode of the electronic device is set to the landscape mode. Similarly, the respective browsing mode may have a corresponding display format.

Additionally, in some embodiments, the change/switch of the browsing mode can be triggered via a touch on a touch screen of the electronic device, and/or via a button of the electronic device.

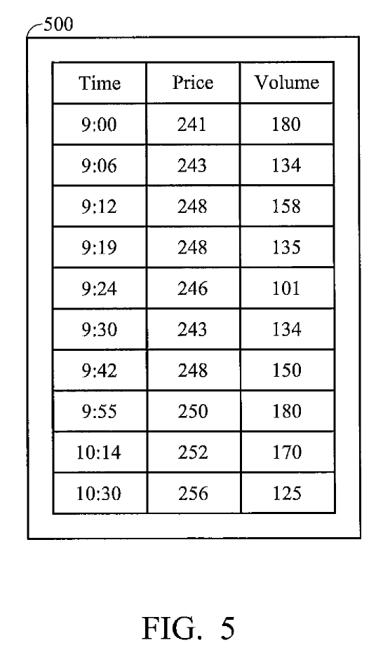

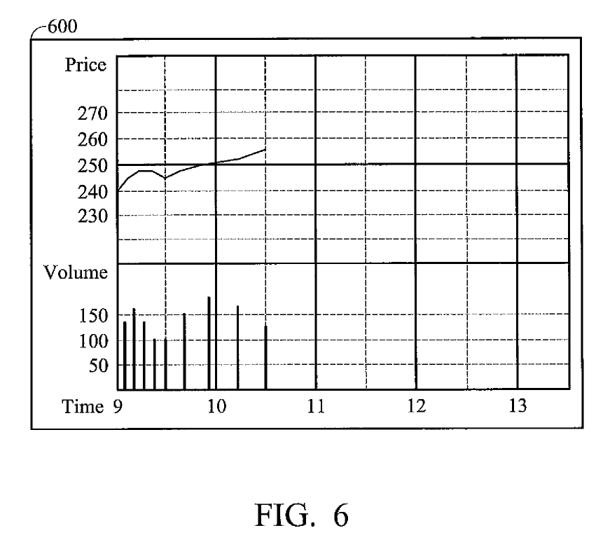

In embodiments of data comprising stock information, data may comprise a time, a price, and a volume for a stock. When the direction of the electronic device is vertical, the browsing mode is automatically set to the portrait mode, and the data is displayed based on the display format of the portrait mode, such that the stock information is displayed via a table, as shown in FIG. 5. When the direction of the electronic device is horizontal, the browsing mode is automatically set to the landscape mode, and the data is displayed based on the display format of the landscape mode, such that the stock information is displayed via a figure, as shown in FIG. 6. It is noted that, the data originally used in the table in FIG. 5 is completely used for generate the figure in FIG. 6.

It is understood that, in the above embodiment, the electronic device only has two directions and two corresponding browsing modes. In some embodiments, however, the electronic device may provide several browsing modes according to various requirements. When the electronic device is at a specific direction, at least one browsing mode can be automatically set.

Therefore, the data display methods and systems of the application can display data in various display formats according to the browsing mode of the electronic device.

Data display methods and systems, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data display method for use in an electronic device, comprising:
providing data;
determining a first display format according to a browsing mode of the electronic device; and
displaying the data based on the first display format.

2. The method of claim 1, further comprising:
when the browsing mode of the electronic device has been changed, re-determining a second display format; and
re-displaying the data based on the second display format.

3. The method of claim 1, further comprising:
detecting a direction of the electronic device; and
setting the browsing mode according to the direction of the electronic device.

4. The method of claim 3, wherein when the direction of the electronic device is vertical, the browsing mode is set to a portrait mode.

5. The method of claim 3, wherein when the direction of the electronic device is horizontal, the browsing mode is set to a landscape mode.

6. The method of claim 2, wherein the data originally used in the first display format is completely used in the second display format for display.

7. The method of claim 6, further comprising:
calculating an output picture conforming to the second display format according to the data originally used in the first display format; and
displaying the output picture.

8. The method of claim 2, wherein the change of the browsing mode is triggered via a touch on a touch screen of the electronic device or via a button of the electronic device.

9. The method of claim 1, wherein when the browsing mode is a portrait mode, the data is displayed in at least one table based on the first display format.

10. The method of claim 1, wherein when the browsing mode is a landscape mode, the data is displayed in at least one figure based on the first display format.

11. A data display system for use in an electronic device, comprising:
a display unit;
a storage unit comprising data; and
a processing unit determining a first display format according to a browsing mode of the electronic device, and displaying the data based on the first display format.

12. The system of claim 11, wherein when the browsing mode of the electronic device has been changed, the processing unit further re-determines a second display format, and re-displays the data based on the second display format.

13. The system of claim 11, further comprising a motion sensor to detect a direction of the electronic device, wherein the processing unit sets the browsing mode according to the direction of the electronic device.

14. The system of claim 13, wherein when the direction of the electronic device is vertical, the processing unit sets the browsing mode to a portrait mode.

15. The system of claim 13, wherein when the direction of the electronic device is horizontal, the processing unit sets the browsing mode to a landscape mode.

16. The system of claim 12, wherein the data originally used in the first display format is completely used in the second display format for display.

17. The system of claim 16, wherein the processing unit further calculates an output picture conforming to the second display format according to the data originally used in the first display format, and displays the output picture.

18. The system of claim 12, wherein the change of the browsing mode is triggered via a touch on a touch screen of the electronic device or via a button of the electronic device.

19. The system of claim 11, wherein when the browsing mode is a portrait mode, the processing unit displays the data in at least one table based on the first display format.

20. The system of claim 11, wherein when the browsing mode is a landscape mode, the processing unit displays the data in at least one figure based on the first display format.

21. A machine-readable storage medium comprising a computer program, which, when executed, causes a device to perform a data display method, and the method comprising:
determining a first display format according to a browsing mode of the electronic device; and
displaying data based on the first display format.
